(19) United States
(12) Patent Application Publication
(10) Pub. No.: US 2013/0198446 A1
(43) Pub. Date: Aug. 1, 2013

(54) STORAGE SYSTEM FOR ATOMIC WRITE OF ONE OR MORE COMMANDS

(71) Applicants: Yechiel YOCHAI, D.N. Menashe (IL); Ido BEN-TSION, Ramat Gan (IL)

(72) Inventors: Yechiel YOCHAI, D.N. Menashe (IL); Ido BEN-TSION, Ramat Gan (IL)

(73) Assignee: INFINIDAT LTD., Herzliya (IL)

(21) Appl. No.: 13/361,369

(22) Filed: Jan. 30, 2012

(51) Int. Cl. G06F 12/08

(52) U.S. Cl. 711/113; 711/E12.019

(57) ABSTRACT

Storage systems which allow atomic write operations, methods of operating thereof, and corresponding computer program products. By way of non-limiting example, a possible method includes: receiving indication of a transaction, where a plurality of blocks directed to at least one destination logical volume and relating to at least one command is to be written as an atomic write operation; generating a transaction identifier number for the transaction; enabling tracking of the transaction at least partly based on the transaction identifier number, including temporary location of any one of the plurality of blocks; accommodating at least one block of the plurality temporarily in the storage system; and upon receiving an indication that all blocks in the plurality have been successfully temporarily accommodated in the storage system, enabling data corresponding to the plurality of blocks to subsequently be stored in the at least destination logical volume and discontinuing tracking of the transaction.

### CROSS-REFERENCE TO RELATED APPLICATIONS

This application is related to simultaneously-filed application Ser. No. ______ titled “Storage System for Atomic Write which includes a Pre-cache”, Inventors Yechiel Yochai et al, filed on Jan. 30, 2012, which is hereby incorporated herein by reference in its entirety.

### TECHNICAL FIELD

The presently disclosed subject matter relates to data storage systems and to methods of operating thereof.

### BACKGROUND

The SCSI (Small Computer System Interface) protocol is able to ensure the sanity and correctness of performing a command only at the level of the individual block and not at the level of the sequence of blocks that can be part of an individual command. Thus, for instance, if a host sends a request to the storage system to write a sequence of blocks, from Logical Block Address (LBA) n to LBA m in a given volume V, and the entire command is performed correctly, then the storage system will return an acknowledgement to the storage system, meaning that all blocks were written and stored correctly according to the request. However if the command is suspended in the middle of its execution (because, for example, the host and/or storage system breaks down before completion, or for any other reason) then obviously no acknowledgement message will be sent from the storage system to the host, because not the entire command was properly executed. However, this does not mean that none of the blocks were modified. Indeed, it is quite likely in a situation like this that some of the blocks were already written to cache and subsequently modified in the permanent storage, but not all of them. Hence there is an inconsistent situation in which it is not known which of the blocks intended in the command are stored as previous to the failed command and which in accordance with the command.

The above is a well-known problem which is typically solved at the level of the host, meaning that if the host sent the request and no acknowledgement was received, for one reason or another, then the host will resend the same write request. Blocks that were modified with the first, failed write command will be rewritten anyway, and will receive the intended content, but now, if the command is completed in its entirety, also those blocks that were not properly modified in the first, failed attempt will now be modified accordingly, and the final situation will be consistent and complete. But again, this is the responsibility of the host and it can either succeed or fail. The storage system cannot guarantee for it and no such recovery methods are foolproof, especially in scenarios with multiple component failure.

### SUMMARY

In accordance with certain aspects of the presently disclosed subject matter, there is provided a method of operating a storage system which includes a control layer, the control layer including a cache memory, and a cache control module, and the control layer operatively coupled to a physical storage space including a plurality of storage disk drives, the method comprising: receiving an indication of a transaction, where a plurality of blocks directed to at least one destination logical volume and relating to at least one command is to be written as an atomic write operation; generating a transaction identifier number for the transaction; enabling tracking of the transaction at least partly based on the transaction identifier number, including temporary location of any one of the plurality of blocks; accommodating at least one block of the plurality temporarily in the storage system; and upon receiving an indication that all blocks in the plurality have been successfully temporarily accommodated in the storage system, enabling data corresponding to the plurality of blocks to subsequently be stored in the at least destination logical volume and discontinuing tracking of the transaction.

In some of these aspects, the plurality of blocks is associated with a plurality of commands.

Additionally or alternatively, in some of these aspects, the method further comprises: creating at least one temporary logical volume in the physical storage space for temporary accommodation; wherein the enabling data corresponding to the plurality of blocks to subsequently be stored in the at least destination logical volume includes: merging data corresponding to blocks accommodated in the at least one temporary logical volume with data in the at least one destination logical volume.

Additionally or alternatively, in some of these aspects, the at least one block is temporarily accommodated in the cache memory with destaging deferred until receipt of an indication that all blocks in the plurality have been successfully temporarily accommodated in the storage system; and wherein the enabling data corresponding to the plurality of blocks to subsequently be stored in the at least destination logical volume includes: allowing the data to undergo destaging.

Additionally or alternatively, in some of these aspects, at least two blocks of the plurality originate from different external hosts.

Additionally or alternatively, in some of these aspects, the storage system communicates with at least one external host using an SCSI protocol.

Additionally or alternatively, in some of these aspects, a commit write command is the indication that all blocks have been successfully temporarily accommodated in the storage system.

Additionally or alternatively, in some of these aspects, the method further comprises: upon receiving instead an indication that an event has occurred which precludes at least one block in the plurality from being successfully temporarily accommodated in the storage system, discarding data in the storage system which correspond to the transaction and discontinuing tracking of the transaction. In some cases of these aspects, the event includes a failure at an external host or in a connection with a host port.

Additionally or alternatively, in some of these aspects, the enabling tracking includes: adding an entry for the transaction to a table or other data structure which tracks active atomic write operations.

In accordance with further aspects of the presently disclosed subject matter, there is provided a storage system, comprising: a physical storage space including a plurality of storage disk drives; a control layer including a volatile memory control module and a cache memory, the control layer operatively coupled to the physical storage space and operable to: receive an indication of a transaction where a plurality of blocks directed to at least one destination logical volume and relating to at least one command is to be written as an atomic write operation; generate a transaction identifier number for the transaction; enable tracking of the transaction at least partly based on the transaction identifier number, including temporary location of any one of the plurality of blocks; accommodate at least one block in the plurality temporarily in the storage system; and upon receiving an indication that all blocks in the plurality have been successfully temporarily accommodated in the storage system, enable data corresponding to the plurality of blocks to subsequently be stored in the at least destination logical volume and discontinue tracking of the transaction.

Additionally or alternatively, in some of these aspects, the plurality of blocks is associated with a plurality of commands.

Additionally or alternatively, in some of these aspects, the control layer is further operable to: create at least one temporary logical volume in the physical storage space for temporary accommodation; and wherein operable to enable data corresponding to the plurality of blocks to subsequently be stored in the at least destination logical volume includes: operable to merge data corresponding to blocks accommodated in the at least one temporary logical volume with data in the at least one destination logical volume.

Additionally or alternatively, in some of these aspects, the at least one block is temporarily accommodated in the cache memory with destaging deferred until receipt of an indication that all blocks in the plurality have been successfully accommodated in the storage system; and wherein operable to enable data corresponding to the plurality of blocks to subsequently be stored in the at least destination logical volume includes: allowing the data to undergo destaging.

Additionally or alternatively, in some of these aspects, at least two blocks of the plurality originate from different external hosts.

Additionally or alternatively, in some of these aspects, the storage system is operable to communicate with at least one external host using an SCSI protocol.

Additionally or alternatively, in some of these aspects, a write commit command is the indication that all blocks have been successfully accommodated in the storage system.

Additionally or alternatively, in some of these aspects, the control layer is further operable to: upon receiving instead an indication that an event has occurred which precludes at least one block in the plurality from being successfully temporarily accommodated in the storage system, discard data in the storage system which corresponds to the transaction and discontinue tracking of the transaction. In some cases of these aspects, the event includes a failure at an external host or in a connection with an external host port.

Additionally or alternatively, in some of these aspects, operable to enable tracking includes: operable to add an entry for the transaction to a table or other data structure which tracks active atomic write operations.

In accordance with further aspects of the presently disclosed subject matter, there is provided a computer program product comprising a non-transitory computer useable medium having computer readable program code embodied therein for operating a storage system which includes a control layer, the control layer including a cache memory, and a cache control module, and the control layer operatively coupled to a physical storage space including a plurality of storage disk drives, the computer program product comprising: computer readable program code for causing the computer to receive an indication of a transaction, where a plurality of blocks directed to at least one destination logical volume and relating to at least one command is to be written as an atomic write operation; computer readable program code for causing the computer to generate a transaction identifier number for the transaction; computer readable program code for causing the computer to enable tracking of the transaction at least partly based on the transaction identifier number, including temporary location of any one of the plurality of blocks; computer readable program code for causing the computer to accommodate at least one block of the plurality temporarily in the storage system; and computer readable program code for causing the computer, upon receiving an indication that all blocks in the plurality have been successfully temporarily accommodated in the storage system, to enable data corresponding to the plurality of blocks to subsequently be stored in the at least destination logical volume and to discontinue tracking of the transaction.

### BRIEF DESCRIPTION OF THE DRAWINGS

In order to understand the subject matter and to see how it can be carried out in practice, examples will be described, with reference to the accompanying drawings, in which:

FIG. 1 illustrates an example of a storage system, in accordance with certain embodiments of the presently disclosed subject matter;

FIG. 2 is a flow-chart of a method of handing an atomic write operation, in accordance with certain embodiments of the presently disclosed subject matter;

FIG. 3 is a flow-chart of a method of handing an atomic write operation, in accordance with certain embodiments of the presently disclosed subject matter; and

FIG. 4 is a flow-chart of a method of aborting one or more atomic write operations, in accordance with certain embodiments of the presently disclosed subject matter.

### DETAILED DESCRIPTION OF THE DRAWINGS

In the following detailed description, numerous specific details are set forth in order to provide a thorough understanding of the presently disclosed subject matter. However, it will be understood by those skilled in the art that the presently disclosed subject matter can be practiced without these specific details. In other non-limiting instances, well-known methods, procedures, components and circuits have not been described in detail so as not to obscure the presently disclosed subject matter.

As used herein, the phrases “for example,” “such as”, “for instance”, “e.g.” and variants thereof describe non-limiting embodiments of the subject matter.

Unless specifically stated otherwise, as apparent from the following discussions, it is appreciated that throughout the specification discussions utilizing terms such as “processing”, “computing”, “calculating”, “determining”, “generating”, “reading”, “writing”, “classifying”, “allocating”, “performing”, “storing”, “managing”, “configuring”, “caching”, “destaging”, “assigning”, “associating”, “transmitting”, “enabling”, “discontinuing”, “accommodating”, “discarding”, “moving”, “generating”, “adding”, “tracking”, “deleting”, “removing”, ensuring”, “moving”, “re-assigning”, “preventing”, “completing”, “releasing”, “receiving”, “communicating”, “migrating”, “merging”, “creating”, “establishing”, “analyzing”, “acknowledging”, “sending”, “operating”, or the like, refer to the action and/or processes of a computer that manipulate and/or transform data into other data, said data represented as physical, such as electronic, quantities and/or said data representing the physical objects. The term “computer” should be expansively construed to cover any kind of electronic system with data processing capabilities, including, by way of non-limiting example, storage system and part(s) thereof disclosed in the present application.

The operations in accordance with the teachings herein can be performed by a computer specially constructed for the desired purposes or by a general purpose computer specially configured for the desired purpose by a computer program stored in a computer readable storage medium.

Embodiments of the presently disclosed subject matter are not described with reference to any particular programming language. It will be appreciated that a variety of programming languages can be used to implement the teachings of the presently disclosed subject matter as described herein.

In the drawings and descriptions, identical reference numerals are used for like components.

Certain embodiments of the currently disclosed subject matter address the question of consistency at the level of the block system and enable implementing an “atomic write” operation that either succeeds or fails in its entirety and not in a partial way that can give rise to inconsistency.

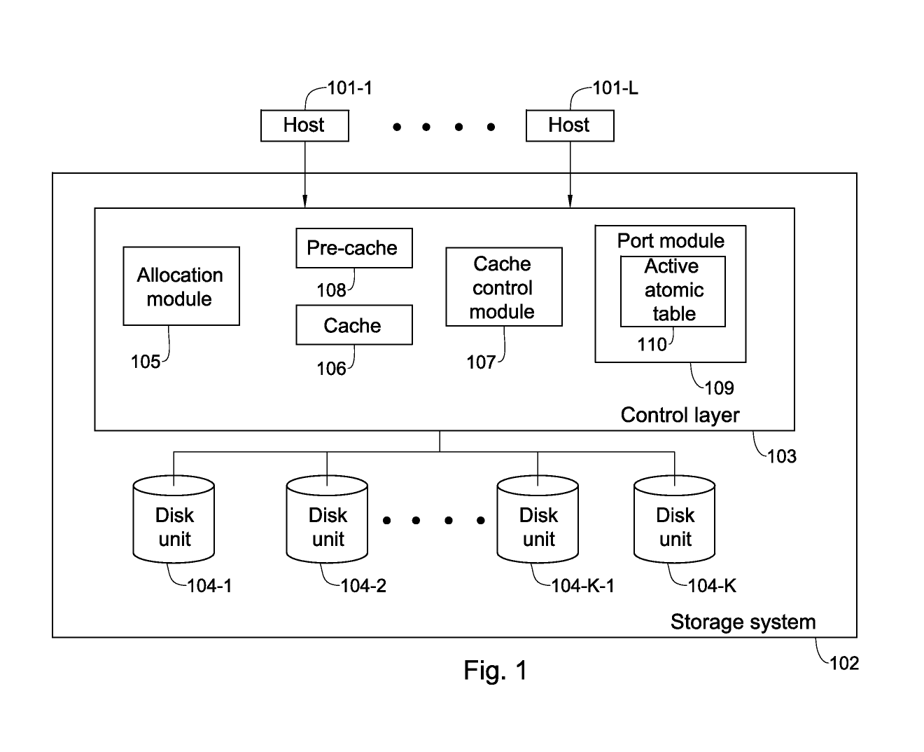

Bearing this in mind, attention is drawn to FIG. 1 illustrating an example of a storage system, in accordance with certain embodiments of the presently disclosed subject matter.

A plurality of external host computers (workstations, application servers, etc.) illustrated as 101-1-101-L share common storage means provided by a storage system 102. The storage system comprises a storage control layer 103 comprising one or more appropriate storage control devices operatively coupled to the plurality of host computers, and a plurality of data storage devices (e.g. disk units 104-1-104-k) constituting a physical storage space optionally distributed over one or more storage nodes, wherein the storage control layer is operable to control interface operations (including I/O operations) there between. Optionally, the storage control layer can be further operable to handle a virtual representation of physical storage space and to facilitate necessary mapping between the physical storage space and its virtual representation. In embodiments with virtualization, the virtualization functions can be provided in hardware, software, firmware or any suitable combination thereof. Optionally, the functions of the control layer can be fully or partly integrated with one or more host computers and/or storage devices and/or with one or more communication devices enabling communication between the hosts and the storage devices. Optionally, a format of logical representation provided by the control layer can differ depending on interfacing applications.

The physical storage space can comprise any appropriate permanent storage medium and can include, by way of non-limiting example, one or more disk drives and/or one or more disk units (DUs), comprising several disk drives. Possibly, the DUs can comprise relatively large numbers of drives, in the order of 32 to 40 or more, of relatively large capacities, typically although not necessarily 1-2 TB. Possibly the permanent storage medium can include disk drives not packed into disk units. The storage control layer and the storage devices can communicate with the host computers and within the storage system in accordance with any appropriate storage protocol.

Stored data can possibly be logically represented to a client in terms of logical objects. Depending on storage protocol, the logical objects can be logical volumes, data files, image files, etc. A logical volume (also known as logical unit) is a virtual entity logically presented to a client as a single virtual storage device. The logical volume represents a plurality of data blocks characterized by successive Logical Block Addresses (LBA) ranging from 0 to a number N(LUi). Different logical volumes can comprise different numbers of data blocks, while the data blocks are typically although not necessarily of equal size (e.g. 512 bytes). Blocks with successive LBAs can be grouped into portions that act as basic units for data handling and organization within the system. Thus, by way of non-limiting instance, whenever space has to be allocated on a disk drive or on a memory component in order to store data, this allocation can be done in terms of data portions. Data portions are typically although not necessarily of equal size throughout the system. (By way of non-limiting example, the size of data portion can be 64 Kbytes).

The storage control layer can comprise a Cache Memory 106 operable as part of the IO flow in the system, and a Cache Control Module (aka Cache Controller) 107 operable to regulate data activity in the cache. Optionally, the storage control layer can further comprise a Port Module 109 operable to control communication and data transmission with hosts, a Pre-Cache Memory 108 operable in certain embodiments to accommodate received block(s) while any additional block(s) associated with the same atomic write operation is/are still being received as will be explained in more detail below, and/or an Allocation Module 105 operable to allocate to the physical storage space.

In certain embodiments which include a pre-cache, the cache control module can be adapted to also control activity in the pre-cache, and therefore can also be termed a volatile memory control module. It is assumed in these embodiments that volatile memory [e.g. (Random Access Memory) RAM memory in each server] can be configured into cache memory and pre-cache memory, meaning that a particular block in volatile memory can function as a cache memory block and/or as a pre-cache memory block. In particular the volatile memory control module can control how parts of volatile memory are assigned to the cache and to the pre-cache. By way of non-limiting example, the area of the pre-cache can be determined in advance and can be static. Alternatively, by way of another non-limiting example, the volatile memory control module can be adapted to decide to increase or reduce the size of the pre-cache area dynamically in accordance with the current activity in the storage system. In some non-limiting instances of the latter example, the area including memory blocks where data was accommodated can be subsequently assigned as pre-cache area, and/or the pre-cache area including the memory blocks where the data was accommodated can be subsequently reassigned as cache area, etc.

Certain embodiments include tracking of an atomic write operation, as will be described in more detail below. By way of non-limiting example, one or more Active Atomic Table(s) 110 and/or other data structure(s) in the storage control layer can be used to keep track of atomic write operation(s). The active atomic table(s) and/or other data structure(s) can be included in the port module and/or elsewhere, in order to keep track of atomic write operation(s). Depending on the instance of this example, table(s) and/or other data structure(s) can be dynamically created when needed, or can exist even when there are no currently active atomic write operations. In another example, alternatively or additionally, tracking can be performed in any suitable module(s) in the storage control layer in any suitable way.

The cache memory, cache control module (or volatile memory control module), port module (when included), pre-cache (when included) and allocation module (when included) can be implemented as centralized modules operatively connected to the plurality of storage control devices, or can be distributed over part of or all of the storage control devices.

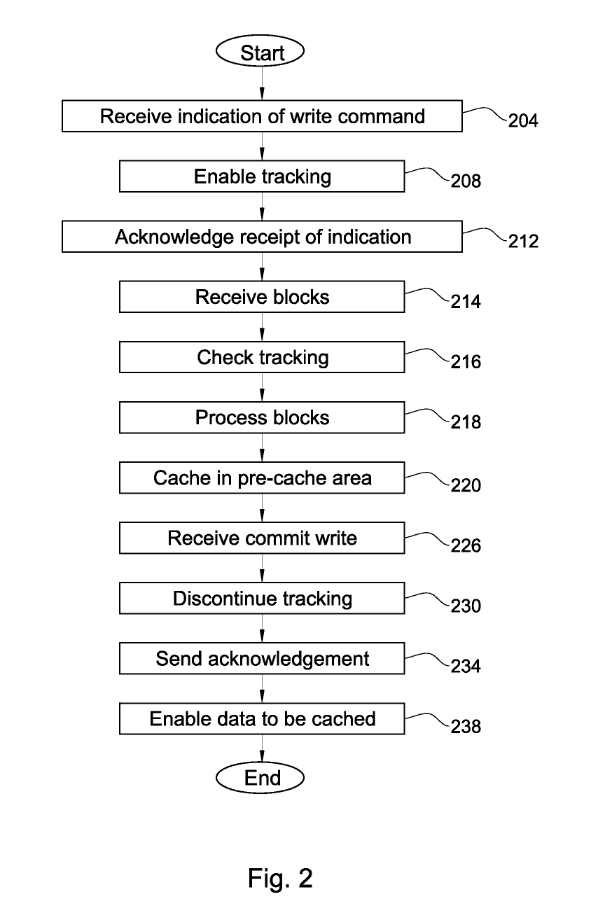

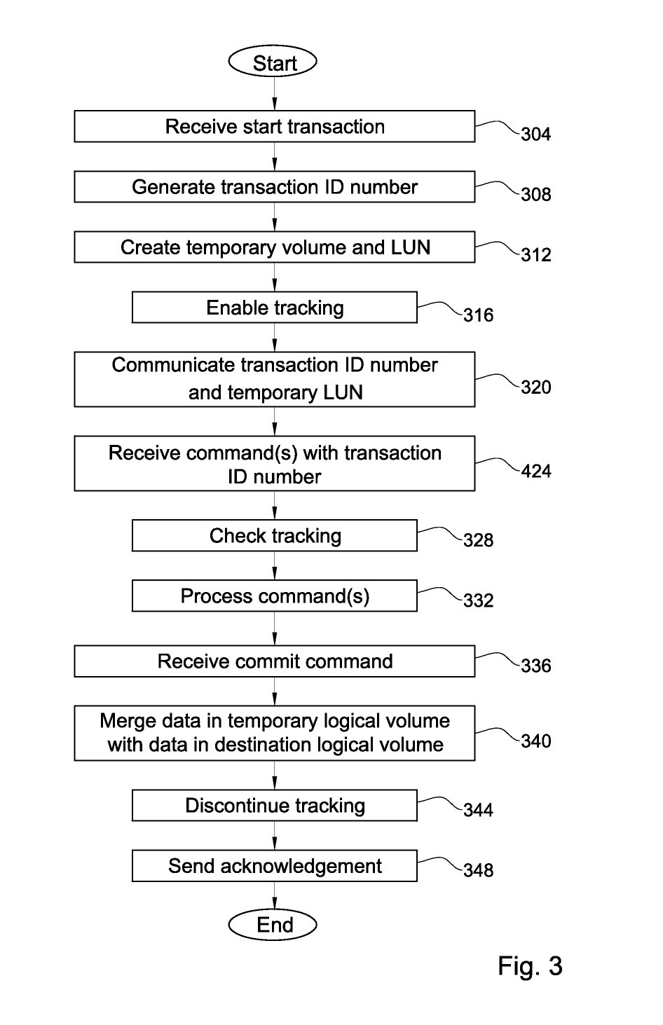

For purpose of illustration only, certain embodiments of FIGS. 2 and 3 are described below with reference to external host(s) communicating with the storage system using the SCSI protocol. Those skilled in the art will readily appreciate that the teachings of the presently disclosed subject matter relating to atomic write operations are not bound by the SCSI protocol and are applicable to other protocols in a variety of implementations, mutatis mutandis.

It is noted that in the SCSI protocol, it is the responsibility of the external host or hosts to ensure that two or more conflicting write operations are not simultaneously addressed to the same extent of logical blocks addresses. For simplicity of description, it is assumed that whichever protocol is used for data originating from external host(s), the host(s) can ensure that two or more conflicting write operations are not addressed to the same extent of logical blocks addresses.

The storage system can operate as illustrated in FIG. 2 which is a flow-chart of a method of handling an atomic write operation, in accordance with certain embodiments of the presently disclosed subject matter.

It is assumed for this method that volatile memory has been configured into cache and pre-cache, meaning that a particular volatile memory block can function as a cache memory block and/or as pre-cache memory block. It is also assumed for this method that the blocks of data which are to be written as an atomic write operation relate to a single command, for instance from a single initiator host port and therefore from a single external host (e.g. from one of hosts 101-1 to 101-L), noted below as H.

Before sending an indication of a write command which is to be handled as an atomic write operation, H can define the command, for example at the level of the operating system. The current subject matter does not limit the definition, but in some non-limiting examples the definition can comprise, inter-alia, an indication of the logical volume (e.g. Vx) to which the command is addressed, the initial LBA of the extent, the length of the extent in blocks, the host port HP from which a connection is to be made, and/or a specification of the timeout. Alternatively, there can be a default timeout defined overall in the storage system, and therefore H would not need to indicate the timeout each time an indication of a write command is sent.

The storage system (e.g. the port module) receives (204) from H an indication of the incoming write command which is to be handled as an atomic write operation addressed for instance from LBA n to m of a particular (destination) logical volume (e.g. Vx). The indication can optionally include a specification of the timeout. It is noted that if no indication is received that the incoming write command is to be handled as an atomic write operation, the write command can be processed conventionally rather than as described below.

Assuming the SCSI protocol, H can send the indication in any appropriate way using commands of the SCSI protocol.

For instance, in SPC-4 of “IT SCSI Primary Commands” (Revision 33 dated 24 Oct. 2011, pages 410-411), which is hereby incorporated by reference herein, the “write buffer” command is described for data mode (02H). The description states “In this mode, the Data-Out” Buffer contains buffer data destined for the logical unit. The BUFFER ID field identifies a special buffer within the logical unit. The vendor assigns buffer ID codes to buffers with the logical unit. Buffer ID zero shall be supported”. Therefore using this mode, H can transfer data, such as parameter(s) that will be used in tracking (see 208 below), plus a notification to the storage system to activate a function that will enable tracking using these parameters.

The storage system (e.g. port module) enables (208) tracking of the atomic write operation. For instance, the storage system can add an entry relating to the indicated write command which is to be handled as an atomic write operation to a table or other data structure which tracks active atomic write operations. Optionally, the table or other data structure can be created at this stage, or could have been created previously.

Table 1 shows an example of an active atomic table with an entry added for the indicated write command, assuming that the indicated write command is not the only currently active command which is to be handled as an atomic write operation:

TABLE 1

| Target | | | | |
|---|---|---|---|---|
| volume | Initial Logical | Length in | Initiator Host | |
| identifier | Block Address | blocks | Port | Timestamp |
| . . . | . . . | . . . | . . . | . . . |
| Vx | LBAn | LBAm-LBAn | HP | TIME_{y} |

With regard to the entry for the indicated write command in Table 1, the parameters target volume identifier, initial logical block address, length in blocks, and/or initiator host port could have been specified in the received indication of the incoming write command. The timestamp Time_{y} can represent the timeout for the atomic write operation. The timeout can be calculated by the storage system (e.g. port module) on the basis of the time of creation of the entry plus a certain time period which could have been specified as a timeout in the indication or could be a default timeout.

Those skilled in the art will readily appreciate that in embodiments where tracking is assisted by usage of an active atomic table and/or other data structure, the active atomic table and/or other data structure is not bound by the contents and format of Table 1, and that other formats and/or content for an active atomic table and/or data structure can be used instead.

The storage system (e.g. port module) sends (212) a message to H, acknowledging receipt of the indication. For instance, the acknowledgement can be sent conventionally.

The storage system receives (214) blocks transmitted by H for the indicated write command. The transmission and receiving of the blocks can be accomplished conventionally in accordance with the communication protocol between H and the storage system, for instance in accordance with the SCSI protocol.

The storage system, for instance the port module, checks (216) the tracking (e.g. checks active atomic table or other data structure) and determines that the received blocks relate to an atomic write operation. The storage system (e.g. the port module) processes (218) the received blocks as usual, for instance separating the incoming write command into sub-commands, assigning to buffers in memory, etc. However, instead of caching these blocks into an area of volatile memory that is assigned to the cache, for subsequent handling according to the cache routines implemented, the storage system caches (220) into an area associated with the pre-cache. (It is noted that the “pre-cache” area in which the blocks are cached may have been assigned as pre-cache memory prior to caching the blocks or may be assigned as pre-cache memory after the blocks have been cached). The data is kept in this area until a “commit write” command is received.

By way of non-limiting example, different blocks can be at the same or at different stages of 214 to 220 at the same point in time.

After all blocks have been transmitted for the indicated write command which is to be handled as an atomic write operation, H sends a “commit write” command which the storage system receives (226).

Assuming the SCSI protocol, H can send the “commit write” command in any of various ways using commands of the SCSI protocol.

For instance, the “write buffer” for data mode (02H) was discussed above. Using this mode, H can transfer data, such as data that can be used to identify the tracked atomic write operation (e.g. to identity the associated active table entry) plus a commit write command. In this manner, after all the data corresponding to the atomic write operation has been transmitted, H can indicate to the storage system that the storage system can allow the data in pre-cache that corresponds to the atomic write operation to subsequently be cached in the cache.

Additionally or alternatively, for instance, the receiving of the “commit write” command, can be considered an example of receiving an indication that all blocks corresponding to the atomic write operation have been successfully accommodated in pre-cache memory.

The storage system, for instance the port module, discontinues (230) tracking of the atomic write operation corresponding to the received “commit write” command. For example, the storage system can remove from the active atomic table or other data structure the entry corresponding to the received “commit write” command. The storage system then sends (234) an acknowledgment to H. Subsequently, from the point of view of H, the write operation is complete.

The storage system, for instance, the cache control module, enables (238) data which was accommodated in the pre-cache area and which relates to the commit write command to subsequently be cached in cache memory. By way of non-limiting example, the data accommodated in the pre-cache area can be moved to the cache area in volatile memory, or alternatively the memory blocks in pre-cache where the data was accommodated can be reassigned to the cache. Once the data is in cache, the data can eventually be destaged, for instance conventionally.

The storage system can additionally or alternatively operate as illustrated in FIG. 3 which is a flow-chart of a method of handling an atomic write operation, in accordance with certain embodiments of the presently disclosed subject matter.

In the description of this method, an operation which can possibly include more than one command is termed a transaction. A transaction can include for instance, a “start transaction” indication, one or more commands, and an “end transaction” indication. The blocks of data which are associated with the transaction can originate for instance, from a single initiator host port or from multiple initiator host ports. The blocks of data which are associated with the transaction, can relate, for instance, to one or more commands. In the description of this method, the blocks associated with the transaction are to be written as an atomic write operation and therefore the transaction is handled accordingly.

For simplicity of description, it is assumed when describing this method that data is temporarily accommodated in temporary logical volume(s) in the physical storage space. However the method described herein can apply in other embodiments to data temporarily accommodated elsewhere in the storage system such as in the cache (e.g. with special status of deferred destaging), until receiving an indication of successful accommodation of all blocks relating to a transaction, mutatis mutandis.

For simplicity of description, it is also assumed when describing this method that a single extent of LBAs is being written to a single (destination) logical volume. However the method described herein can apply in other embodiments to a single extent of LBA's being written to a plurality of (destination) logical volumes, mutatis mutandis. For instance, in embodiment which includes temporary logical volumes, a plurality of temporary logical volumes and temporary logic unit numbers can be used when the extent is being written to a plurality of (destination) logical volumes.

Before sending an indication of a transaction which is to be handled as an atomic write operation, the external host or one of the external hosts that will be participating in the transaction can define the transaction, for example at the level of the operating system.

The current subject matter does not limit the definition of the transaction, but in some non-limiting examples the definition can comprise, inter-alia, an indication of the (actual) destination logical volume (e.g. Vx) to which the transaction is addressed, the initial LBA of the extent, the length of the extent in blocks, the host port or ports HP from which a connection is to be made, and/or a specification of the timeout. Alternatively, there can be a default timeout defined overall in the storage system, and therefore the host would not need to specify the timeout each time a “start transaction” is sent.

The host or one of the participating hosts sends to the storage system a “start transaction” indication relating to a transaction which is to be handled as an atomic write operation. The storage system (e.g. the port module) receives (304) the “start transaction” indication for the transaction addressed for instance from LBA n to m of a particular destination logical volume (e.g. Vx). The “start transaction” indication can optionally include a specification of the timeout.

Assuming the SCSI protocol, the host can send the “start transaction” indication in any appropriate way using commands of the SCSI protocol.

For instance, the “write buffer” for data mode (02H) was discussed above. Using this mode, a host can transfer data, such as parameter(s) that will be used to generate the transaction ID number (TIDN) (see below 308), to create the temporary logical volume associated with the transaction ID number TV(TIDN) (see below 312), and/or to track the transaction (see below 316), plus an indication to the storage system to activate a function that will perform one or more of these actions using these parameter(s).

In response to the received “start transaction” indication, the storage system, generates (308) a transaction identification number, say TIDN_{z}. The storage system creates (312) a temporary logical volume, say TV(TIDN_{z}), associated with the transaction, and a temporary logic unit number, say TLUN(TIDN_{z}), thereby establishing a connection between a host port HP and the temporary logical volume TV(TIDN_{z}).

The storage system, for instance the port module, enables (316) tracking of the transaction. The tracking which is enabled allows, for instance, tracking of the temporary location(s) in the storage system of data corresponding to the transaction. For instance, the storage system can add an entry relating to the transaction to an active atomic table or other data structure which tracks active atomic write operations. Optionally, the table or other data structure can be created at this stage, or could have been created previously.

Table 2 shows an example of an active atomic table with an entry added for the indicated transaction, assuming that the indicated transaction is not the only currently active transaction which is to be handled as an atomic write operation:

TABLE 2

| Transaction | | Initial | | | |
|---|---|---|---|---|---|
| identification | Target | Logical | Length | | |
| number | volume | Block | in | | |
| (TIDN) | identifier | Address | blocks | TV (TIDN) | Timestamp |
| . . . | . . . | . . . | . . . | . . . | . . . |
| TIDN_{z} | Vx | LBAn | LBAm- | TV (TIDN_{z}) | TIME_{y} |
| | | | LBAn | | |

With regard to the entry for the indicated transaction in Table 2, the parameters target volume identifier, initial logical block address, and/or length in blocks could have been included in the received start transaction indication. The transaction identification number and temporary volume can be generated by the storage system. The timestamp Time_{y} can represent the timeout for the atomic write operation. The timeout can be calculated by the storage system (e.g. port module) on the basis of the time of creation of the transaction entry plus a certain time period which could have been specified as a timeout in the received start transaction indication or could be a default timeout.

Those skilled in the art will readily appreciate that in embodiments where tracking is assisted by usage of an active atomic table and/or other data structure, the active atomic table and/or other data structure is not bound by the contents and format of Table 2, and that other formats and/or content for an active atomic table and/or other data structure can be used instead. For instance in some cases, the temporary volume identifier number column can be deleted, replaced, or supplemented by a column specifying the temporary logical unit number, and/or if the data is not accommodated in a temporary logical volume then the column can be deleted, replaced, or supplemented by a column specifying the temporary location (e.g. cache) where the data is instead accommodated.

The storage system communicates (320) to the external host or participating external hosts the transaction identification number and the associated temporary logical unit number (e.g. TIDN_{z} and TLUN(TIDN_{z})). If using the SCSI protocol, the communication of the transaction identification number and associated temporary logic unit number can be performed in accordance with the SCSI protocol in ways which are known in the art. (By way of non-limiting example, the communication in this stage can also function as an acknowledgement of receipt of the “start transaction” indication or a separate acknowledgement can be sent).

The storage system, for instance the port module, receives (324) one or more incoming write commands with a transaction ID number from a host.

Assuming the SCSI protocol, the host can include the transaction ID number in a write command of the SCSI protocol in any appropriate way.

For instance, in SBC-3 of “SCSI Block Commands-3” (Revision 24 dated 5 Aug. 2010, page 161), which is hereby incorporated by reference herein, the “write(32)” command is described. In various places in the command descriptor block there are reserved bytes such as bytes 2-5 and 6, any of which can be used for including the transaction ID number. Alternatively, the second half of byte 6 which is defined as a “group number” is typically not used and therefore can be used to include the transaction ID number. If four bits are used for the transaction identification number (by way of non-limiting example from the second half of byte 6) then up to 16 active transactions can be handled by storage system concurrently. Similarly, the “write long(16)” command described in “SBC-3 of SCSI Block Commands-3” on pages 169-170, which is hereby incorporated by reference herein, has reserved bytes which can be used for including the transaction ID number.

For each received write command, the storage system, for instance the port module, checks (328) the tracking (e.g. checks active atomic table or other data structure) with the help of the specified transaction identification number and determines that the received write command is associated with a transaction that is being tracked (e.g. associated with a transaction that was previously registered in an active atomic table or other data structure). Therefore, the storage system processes (332) the write command as if directed to the temporary logical volume associated with the specified transaction identification number. (If a write command is received which is not associated with any tracked transaction, then the write command can be processed conventionally rather than as described in stages 332 to 348).

Any additional write commands received with the same transaction identification number (prior to receiving a commit command) are handled as described in stages 324 to 332. By way of non-limiting example, different commands with the same transaction identification number can be at the same or at different stages of 324 to 332 at the same point in time.

Once all the write command(s) associated with the transaction have been transmitted, the external host or one of the participating external hosts sends a “commit write” command (which also functions as an indication of the end of the transaction). The storage system receives (336) the commit command.

For instance, the “write buffer” for data mode (02H) was discussed above. Therefore using this mode, a host can transfer data, such as data that will be used to identify the tracked transaction (e.g. identify the associated active table entry) plus a “commit write” command. In this manner after all the data corresponding to the transaction has been transmitted, a host can indicate to the storage system that the data corresponding to the transaction should be committed.

Additionally or alternatively, for instance, the receiving of the “commit write” command, can be considered an example of receiving an indication that all data corresponding to the atomic write operation has been successfully accommodated in the storage system.

At this point all the data corresponding to this transaction should have been temporarily accommodated in the storage system (e.g. in cache prior to destaging or in the temporary logical volume (e.g. TV(TIDN_{z})) but not as data that is associated with the destination logical volume (e.g. Vx). The data is instead associated with the specified temporary logical volume (e.g. TV(TIDN_{z}). After receiving the “commit write” command, the storage system enables (340) the temporarily accommodated data to be subsequently stored in the destination logical volume. For instance, once all data is accommodated in the temporary logical volume, the storage system can merge data in the temporary logical volume with data in the destination logical volume.

The currently disclosed subject matter does not limit the ways in which data in the temporary logical volume can be merged with data in the destination logical volume. By way of a non-limiting example the data can be merged as disclosed in U.S. Patent Application No. 61/513,811 filed on Aug. 1, 2011, assigned to the assignee of the present application and incorporated herein by reference in its entirety. In that application the term “migrated” was used for “merged”.

Alternatively, if the data relating to the transaction was temporarily accommodated in the cache with a special status (e.g. destaging deferred until receipt of “commit write” command), then upon receiving the “commit write” command, the storage system can enable the temporarily accommodated data relating to the transaction to be stored in the destination logical volume by allowing the data in the cache to undergo the destaging process.

The storage system, for example the port module, discontinues (344) tracking the transaction corresponding to the received commit write command. For example, the storage system can remove from an active atomic table or other data structure the entry corresponding to the transaction for which the received commit write command was received. The storage system sends (348) an acknowledgement to the host which sent the commit command.

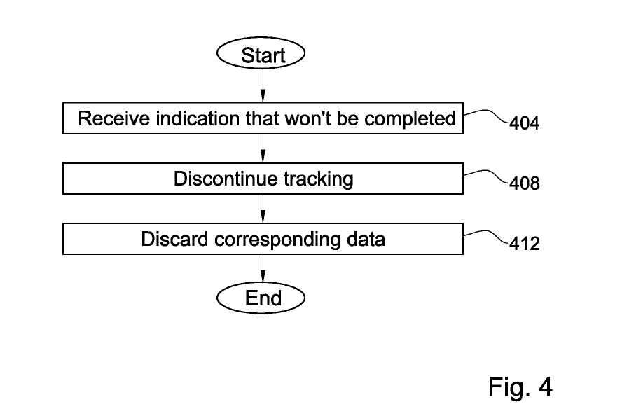

The storage system can additionally or alternatively operate as illustrated in FIG. 4 which is a flow-chart of a method of aborting one or more atomic write operations, in accordance with certain embodiments of the presently disclosed subject matter.

The storage system receives (404) an indication that an event has occurred which precludes one or more currently active atomic write operations from being successfully completed. An event precludes an atomic write operation from being successfully completed if the event precludes at least one block associated with the atomic write operation from being successfully accommodated in the storage system.

By way of a non-limiting example, the event can include a failure which affects transfer of blocks between external host(s) and the storage system, such as a failure at one or more host(s) and/or in the connection(s) between one or more host port(s) and the storage system.

For instance the connection between a host port and a port in the port module could have been continually monitored by the relevant hardware, such as for instance a host bus adaptor HBA in the storage system where the cable is connected. In this non-limiting instance, if there had been a failure (e.g. at host(s) and/or in the connection(s) between host port(s) and the port(s) in the port module), the HBA could have noticed the failure. The HBA could have provided an indication of the failure to the driver and then the driver to the port module. The indication of failure indicates to the storage system that the failure precludes any currently active atomic write operation(s) affected by the failure (e.g. involving the failed host(s) and/or connection(s)) from being successfully completed.

Additionally or alternatively, for instance, the indication could have been received during the monitoring of data reliability. If DIF (Data Integrity Field) is used for data reliability, to every block (say of 512 Bytes) one appends additional bytes (e.g. eight) for reliability. As already stated, the SCSI protocol works at the block level. When a currently active atomic write operation including a plurality of blocks with DIF is being processed by the storage system (e.g. in accordance with any of the above described methods), the storage system checks the validity of the DIF, block after block (e.g. as part of 218 or 332). If the DIF of at least one block is found to be invalid, an indication of the invalidity is received by the storage system. The indication of invalidity indicates to the storage system that there has been a failure (e.g. at host(s) and/or in the connection(s) between host port(s) and the storage system) which precludes this atomic write operation from being successfully completed.

Additionally or alternatively, for instance, the indication could have been received during the monitoring of time-outs. A watchdog procedure running in the control layer (e.g. port module) can periodically check the tracking (e.g. check active atomic table(s) and/or other data structure(s)) for any currently active atomic write operation(s) whose timeout is due. If timeout is due, an indication of timeout can be received by the storage system. The indication of timeout indicates to the storage system that that there has been a failure (e.g. at host(s) and/or in the connection(s)) which precludes the atomic write operation(s) whose timeout is due from being successfully completed.

Optionally after receiving an indication that an event has occurred which precludes one or more currently active atomic write operations from being successfully completed, the storage system can notify the host(s) so that the external host(s) will not send additional blocks and/or will not send a “commit write” command.

The storage system discontinues (408) tracking for any currently actively atomic write operation(s) precluded from being successfully completed. For instance the storage system can remove the entry/ies in the relevant active atomic table(s) and/or other data structure(s) (e.g. Table 1 or Table 2) which represent atomic write operation(s) precluded from being successfully completed. The currently active atomic write operation(s) precluded from being successfully completed for which tracking is discontinued can vary depending on the embodiment. For instance, in various embodiments tracking can be discontinued for all currently active atomic write operation(s) (e.g. that are after 208 and before 230 or after 316 and before 344), for currently active atomic write operation(s) which are affected by failed host(s) and/or connection(s), for currently active atomic write operation(s) with DIF invalidity, for currently active atomic write operation(s) with timeout due, etc.

The storage system, discards (412) all data corresponding to the atomic write operation(s) whose tracking was discontinued. For instance, all data in pre-cache, cache, temporary logical volume(s), and/or elsewhere in the storage system which corresponds to atomic write operation(s) whose tracking was discontinued can be discarded.

If after tracking has been discontinued for an atomic write operation, the storage system receives a data block and/or write command from an external host which relates to the atomic write operation, the block and/or write command can be rejected. For instance, assume that a plurality of write commands is associated with a transaction identification number identifying a transaction which is being handled as an atomic write operation. If an incoming write command with that transaction identification number reaches the storage system after tracking of the transaction has been discontinued, the storage system (e.g. the port module) can reject the command.

Optionally, redundancy can be implemented in the storage system described above, in the pre-cache, in the cache, in the temporary logical volume(s), and/or elsewhere in the storage system. By way of non-limiting example, for any atomic write operation, each piece of data which is written to a primary pre-cache, cache, temporary logical volume(s) (and/or elsewhere) is also written to a secondary pre-cache, cache, temporary logical volume(s) (and/or elsewhere), respectively. The data is kept in the secondary pre-cache, cache, temporary logical volume(s) (and/or elsewhere) until one of the methods described above with respect to FIG. 2 or 3 has been completed. For instance, the data can be kept there until the corresponding data in the primary pre-cache is moved to the cache (or the associated memory blocks are reassigned as cache), until the corresponding data in primary temporary logical volume(s) is merged with the data in primary destination logical volume(s), or until the corresponding data in the primary cache with special status (e.g. deferred destaging) is allowed to undergo the destaging process, etc. Additionally or alternatively, in some cases, if the server which includes the primary pre-cache, cache, temporary logical volume(s) (and/or elsewhere) fails, then the second server with the secondary pre-cache, cache, temporary logical volume(s) (and/or elsewhere) can take over responsibility and continue working using the data in the secondary pre-cache, cache, temporary logical volume (and/or elsewhere). However, in the case of a failure which affects both the primary and secondary servers, the data in both the primary pre-cache, cache, temporary logical volume(s) (and/or elsewhere) and in the secondary pre-cache, cache, temporary logical volume(s) (and/or elsewhere) which corresponds to atomic write operation(s) precluded from being successfully completed is discarded.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

It is also to be understood that any of the methods described herein can include fewer, more and/or different stages than illustrated in the drawings, the stages can be executed in a different order than illustrated, stages that are illustrated as being executed sequentially can be executed in parallel, and/or stages that are illustrated as being executed in parallel can be executed sequentially. Any of the methods described herein can be implemented instead of and/or in combination with any other suitable power-reducing techniques.

It is also to be understood that certain embodiments of the presently disclosed subject matter are applicable to the architecture of storage system(s) described herein with reference to the figures. However, the presently disclosed subject matter is not bound by the specific architecture; equivalent and/or modified functionality can be consolidated or divided in another manner and can be implemented in any appropriate combination of software, firmware and/or hardware. Those versed in the art will readily appreciate that the presently disclosed subject matter is, likewise, applicable to any storage architecture implementing a storage system. In different embodiments of the presently disclosed subject matter the functional blocks and/or parts thereof can be placed in a single or in multiple geographical locations (including duplication for high-availability); operative connections between the blocks and/or within the blocks can be implemented directly (e.g. via a bus) or indirectly, including remote connection. The remote connection can be provided via Wire-line, Wireless, cable, Internet, Intranet, power, satellite or other networks and/or using any appropriate communication standard, system and/or protocol and variants or evolution thereof (as, by way of non-limiting example, Ethernet, iSCSI, Fiber Channel, etc.).

It is also to be understood that for simplicity of description, some of the embodiments described herein ascribe a specific method stage and/or task generally to the storage control layer and/or more specifically to a particular module within the control layer. However in other embodiments the specific stage and/or task can be ascribed more generally to the storage system and/or more specifically to any module(s) in the storage system.

It is also to be understood that the system according to the presently disclosed subject matter can be, at least partly, a suitably programmed computer. Likewise, the presently disclosed subject matter contemplates a computer program being readable by a computer for executing the method of the presently disclosed subject matter. The subject matter further contemplates a machine-readable memory tangibly embodying a program of instructions executable by the machine for executing a method of the subject matter.

Those skilled in the art will readily appreciate that various modifications and changes can be applied to the embodiments of the presently disclosed subject matter as hereinbefore described without departing from its scope, defined in and by the appended claims.

1. A method of operating a storage system which includes a control layer, said control layer including a cache memory, and a cache control module, and said control layer operatively coupled to a physical storage space including a plurality of storage disk drives, the method comprising:
receiving an indication of a transaction, where a plurality of blocks directed to at least one destination logical volume and relating to at least one command is to be written as an atomic write operation;
generating a transaction identifier number for said transaction;
enabling tracking of said transaction at least partly based on said transaction identifier number, including temporary location of any one of said plurality of blocks;
accommodating at least one block of said plurality temporarily in said storage system; and
upon receiving an indication that all blocks in said plurality have been successfully temporarily accommodated in said storage system, enabling data corresponding to said plurality of blocks to subsequently be stored in said at least destination logical volume and discontinuing tracking of said transaction.

2. The method of claim 1, wherein said plurality of blocks is associated with a plurality of commands.

3. The method of claim 1, further comprising:
creating at least one temporary logical volume in said physical storage space for temporary accommodation;
wherein said enabling data corresponding to said plurality of blocks to subsequently be stored in said at least destination logical volume includes: merging data corresponding to blocks accommodated in said at least one temporary logical volume with data in said at least one destination logical volume.

4. The method of claim 1, wherein said at least one block is temporarily accommodated in said cache memory with destaging deferred until receipt of an indication that all blocks in said plurality have been successfully temporarily accommodated in said storage system; and wherein said enabling data corresponding to said plurality of blocks to subsequently be stored in said at least destination logical volume includes: allowing said data to undergo destaging.

5. The method of claim 1, wherein at least two blocks of said plurality originate from different external hosts.

6. The method of claim 1, wherein said storage system communicates with at least one external host using an SCSI protocol.

7. The method of claim 1, wherein a commit write command is said indication that all blocks have been successfully temporarily accommodated in said storage system.

8. The method of claim 1, further comprising:
upon receiving instead an indication that an event has occurred which precludes at least one block in said plurality from being successfully temporarily accommodated in said storage system, discarding data in said storage system which correspond to said transaction and discontinuing tracking of said transaction.

9. The method of claim 8, wherein said event includes a failure at an external host or in a connection with a host port.

10. The method of claim 1, wherein said enabling tracking includes: adding an entry for said transaction to a table or other data structure which tracks active atomic write operations.

11. A storage system, comprising:
a physical storage space including a plurality of storage disk drives;
a control layer including a volatile memory control module and a cache memory, said control layer operatively coupled to said physical storage space and operable to:
receive an indication of a transaction where a plurality of blocks directed to at least one destination logical volume and relating to at least one command is to be written as an atomic write operation;
generate a transaction identifier number for said transaction;
enable tracking of said transaction at least partly based on said transaction identifier number, including temporary location of any one of said plurality of blocks;
accommodate at least one block in said plurality temporarily in said storage system; and
upon receiving an indication that all blocks in said plurality have been successfully temporarily accommodated in said storage system, enable data corresponding to said plurality of blocks to subsequently be stored in said at least destination logical volume and discontinue tracking of said transaction.

12. The system of claim 11, wherein said plurality of blocks is associated with a plurality of commands.

13. The system of claim 11,
wherein said control layer is further operable to: create at least one temporary logical volume in said physical storage space for temporary accommodation; and
wherein operable to enable data corresponding to said plurality of blocks to subsequently be stored in said at least destination logical volume includes: operable to merge data corresponding to blocks accommodated in said at least one temporary logical volume with data in said at least one destination logical volume.

14. The system of claim 11, wherein said at least one block is temporarily accommodated in said cache memory with destaging deferred until receipt of an indication that all blocks in said plurality have been successfully accommodated in said storage system; and wherein operable to enable data corresponding to said plurality of blocks to subsequently be stored in said at least destination logical volume includes: allowing said data to undergo destaging.

15. The system of claim 11, wherein at least two blocks of said plurality originate from different external hosts.

16. The system of claim 11, wherein said storage system is operable to communicate with at least one external host using an SCSI protocol.

17. The system of claim 11, wherein a write commit command is said indication that all blocks have been successfully accommodated in said storage system.

18. The system of claim 11, wherein said control layer is further operable to:
upon receiving instead an indication that an event has occurred which precludes at least one block in said plurality from being successfully temporarily accommodated in said storage system, discard data in said storage system which corresponds to said transaction and discontinue tracking of said transaction.

19. The system of claim 18, wherein said event includes a failure at an external host or in a connection with an external host port.

20. The system of claim 11, wherein operable to enable tracking includes: operable to add an entry for said transaction to a table or other data structure which tracks active atomic write operations.

21. A computer program product comprising a non-transitory computer useable medium having computer readable program code embodied therein for operating a storage system which includes a control layer, said control layer including a cache memory, and a cache control module, and said control layer operatively coupled to a physical storage space including a plurality of storage disk drives, the computer program product comprising:
computer readable program code for causing the computer to receive an indication of a transaction, where a plurality of blocks directed to at least one destination logical volume and relating to at least one command is to be written as an atomic write operation;
computer readable program code for causing the computer to generate a transaction identifier number for said transaction;
computer readable program code for causing the computer to enable tracking of said transaction at least partly based on said transaction identifier number, including temporary location of any one of said plurality of blocks;
computer readable program code for causing the computer to accommodate at least one block of said plurality temporarily in said storage system; and
computer readable program code for causing the computer, upon receiving an indication that all blocks in said plurality have been successfully temporarily accommodated in said storage system, to enable data corresponding to said plurality of blocks to subsequently be stored in said at least destination logical volume and to discontinue tracking of said transaction.
